(19) United States
(12) Patent Application Publication
(10) Pub. No.: US 2026/0307712 A1
(43) Pub. Date: Oct. 8, 2026

(54) STEERING GEAR COMPRISING A BALL SCREW DRIVE, AND STEERING SYSTEM COMPRISING THE STEERING GEAR

(71) Applicant: ZF ACTIVE SAFETY AND ELECTRONICS US LLC, Livonia, MI (US)

(72) Inventors: Bastian Eßer, Wegberg (DE); Florian Zihm, Essen (DE)

(21) Appl. No.: 19/476,722

(22) PCT Filed: Apr. 23, 2024
(86) PCT No.: PCT/IB2024/053945

§ 371 Date: Oct. 20, 2025

(30) Foreign Application Priority Data
Apr. 25, 2023 (DE) 10 2023 203 807.2

(51) Int. Cl. B62D 5/04

(52) U.S. Cl. CPC B62D 5/0448

(57) ABSTRACT

A steering gear for a steering system of a vehicle, including a gear housing, the gear housing having a cylinder chamber, a threaded spindle rotatably mounted in the gear housing, the threaded spindle having an input interface for connecting a steering drive, and a segment shaft rotatably mounted in the gear housing. The segment shaft has an output interface for connecting to a steering linkage. The steering gear further includes a ball nut device which is guided axially in relation to a first axis of rotation of the threaded spindle and which has a lateral surface and a toothed portion for meshing engagement with the segment shaft. The ball nut device forms, together with the threaded spindle, a ball screw drive. The lateral surface is supported in some portions in at least one fixed contact region on an inner circumference of the cylinder chamber in a circumferential direction.

### CROSS REFERENCE TO RELATED APPLICATIONS

This application is a U.S. National Phase application under 35 U.S.C. § 371 of International Application No. PCT/IB2024/053945, filed on Apr. 23, 2024, and claims benefit to German Patent Application No. DE 10 2023 203 807.2, filed on Apr. 25, 2023. The International Application was published in German on Oct. 31, 2024 as WO 2024/224280 A1 under PCT Article 21(2).

### FIELD

The invention relates to a steering gear for a steering system of a and to a steering system comprising the steering gear.

### BACKGROUND

Ball screw gears, also denoted as recirculating ball gears, for steering systems of vehicles are known, said ball screw gears converting a steering command of a steering wheel into a rotational movement of the steerable vehicle wheels. Such ball screw gears substantially have an input shaft and an output shaft which are operatively connected to one another via a ball screw drive. To this end, the input shaft is configured as a screw spindle which, together with a spindle nut in meshing engagement with the output shaft, forms the ball screw drive.

The publication DE 10 2014 106 488 A1 discloses a recirculating ball steering system with a steering housing in which a steering piston is mounted between a first working chamber and a second working chamber, wherein the steering piston has a toothed region on its steering piston outer wall into which teeth of a segment shaft engage, and is displaceable along a longitudinal axis, wherein the working chambers are connected to a control valve via pressure medium lines for steering assistance. At least one sliding element is arranged between a steering housing inner wall and a steering piston outer wall on a side of the steering piston facing away from the toothing.

### SUMMARY

In an embodiment, the present disclosure provides a steering gear for a steering system of a vehicle, comprising a gear housing, wherein the gear housing has a cylinder chamber, a threaded spindle rotatably mounted in the gear housing, wherein the threaded spindle has an input interface for connecting a steering drive, and a segment shaft rotatably mounted in the gear housing, wherein the segment shaft has an output interface for connecting to a steering linkage. The steering gear further comprises a ball nut device which is guided axially in relation to a first axis of rotation of the threaded spindle and which has a lateral surface and a toothed portion for meshing engagement with the segment shaft. The ball nut device forms, together with the threaded spindle, a ball screw drive. The lateral surface is supported in some portions in at least one fixed contact region on an inner circumference of the cylinder chamber in a circumferential direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a sectional view of a steering gear for a steering system of a vehicle according to an embodiment of the present disclosure;

FIG. 2 illustrates a further sectional view of a steering gear for a steering system of a vehicle according to an embodiment of the present disclosure; and

FIG. 3 illustrates a schematic view of an electric steering system having the steering gear of FIG. 1.

### DETAILED DESCRIPTION

In an embodiment, the present disclosure provides a steering gear of the type mentioned above which is characterized by an improved operating behavior.

Advantageous embodiments are found in the drawings and/or the description.

In an embodiment, the present disclosure provides a steering gear which is configured and/or suitable for a steering system. In particular, the steering gear serves for transmitting a steering movement to one or more vehicle wheels of a vehicle.

The steering gear comprises a gear housing with a cylinder chamber, wherein a threaded spindle and a segment shaft are rotatably mounted in the gear housing. In particular, the threaded spindle and the segment shaft are oriented transversely to one another. In other words, the threaded spindle defines a first axis of rotation and the segment shaft defines a second axis of rotation, wherein the two axes of rotation intersect in a plan view, in particular at right-angles. In particular, a threaded spindle is understood to mean a shaft which has a helical raceway for guiding at least one row of balls. In particular, a segment shaft is understood to mean a shaft which has a tooth geometry which is configured as a segment toothing. In particular, the tooth geometry extends in the circumferential direction over an angular range of less than 270 degrees, preferably less than 180. Preferably, the threaded spindle is arranged coaxially and/or concentrically in the cylinder chamber in relation to the first axis of rotation. In other words, the cylinder chamber extends in the axial direction to the first axis of rotation and/or circumferentially to the first axis of rotation.

The threaded spindle has an input interface which is configured and/or suitable for connecting a steering drive. In principle, the input interface can be connected to a steering spindle or a steering column in order to transmit a steering movement applied by a steering handle, in particular a steering wheel, to the threaded spindle. Alternatively or optionally additionally, the input interface can be connected to a drive motor, preferably an electric servomotor, in order to transmit a steering movement generated by the drive motor to the threaded spindle. The input interface can be configured as a shaft journal which protrudes on the end side out of the gear housing and on which the steering column and/or the drive motor is attached in terms of drive technology.

The segment shaft has an output interface which is configured and/or suitable for transmitting a steering movement to one or more, preferably two, vehicle wheels. The output interface can be configured as a further shaft journal which protrudes on the end side out of the gear housing and which is connected via known kinematic connections to the at least one vehicle wheel, in order to change a wheel steering angle on the vehicle wheel during a rotation of the output shaft.

The steering gear comprises a ball nut device which is guided axially in relation to the first axis of rotation and which has a lateral surface and a toothed portion for meshing engagement with the segment shaft. In principle, the ball nut device can be produced in one piece, in particular from one material portion. Alternatively, however, the ball nut device can also be configured in multiple parts, in particular substantially in two parts. In particular, the toothed portion is configured in some portions or partially on the outer circumference in the axial direction and/or circumferential direction in relation to the first axis of rotation or incorporated in the lateral surface. Preferably, the toothed portion is configured as a rack toothing which extends partially or fully over the axial length of the guide sleeve.

The ball nut device forms together with the threaded spindle a ball screw drive. In particular, the ball nut device serves to convert a rotational movement of the threaded spindle about the first axis of rotation into a rotational movement of the segment shaft about the second axis of rotation. Preferably, the ball nut device, on the one hand, is connected in terms of drive via at least one row of balls to the threaded spindle and, on the other hand, is in meshing engagement with the segment shaft or the tooth geometry thereof via the toothed portion. Preferably, the ball nut device on the inside also has at least one circumferential and/or helical raceway which together with the raceway of the threaded spindle forms at least one ball race channel for guiding the balls of the at least one row of balls. When transmitting the steering movement, the threaded spindle is rotated about the first axis of rotation, whereby the ball nut device moves in the axial direction in relation to the first axis of rotation in the gear housing and thus drives the segment shaft about the second axis of rotation.

In the context of the present disclosure, it is provided that the lateral surface is supported in some portions in at least or exactly one fixed contact region on an inner circumference of the cylinder chamber in the circumferential direction. In simple terms, the ball nut device is supported radially with no play or with little play and axially slidably guided or slidably mounted in relation to the first axis of rotation in the contact region. In particular, “little play” is understood to mean that the lateral surface is supported in the radial direction in relation to the first axis of rotation in the contact region with a small amount of radial play on the inner circumference of the cylinder chamber. For example, the radial play in the contact region can be less than 50 μm, preferably less than 30 μm, in particular less than 10 μm. In particular, a fixed contact region is understood to mean a contact between the lateral surface and the inner circumference of the cylinder chamber which remains unchangeable and/or fixed in terms of rotation, with an axial movement of the ball nut at least in the circumferential direction. Preferably, the lateral surface outside the contact region is arranged spaced-apart and/or contactlessly relative to the inner circumference. In principle, the lateral surface in the contact region can be supported via at least or exactly one point contact on the inner circumference. Alternatively, the lateral surface in the contact region is supported via a linear contact on the inner circumference. In particular, the linear contact is defined by a contact line which substantially extends in the axial direction in relation to the first axis of rotation. In particular, the lateral surface has a non-circular outer contour when viewed in a cross section. In particular, “non-circular” is understood to mean that the lateral surface has an outer contour deviating from the cylindrical, in particular round, cross-sectional shape of the cylinder chamber. For example, the lateral surface can have substantially an elliptical or polygonal shape.

The present disclosure is based on the recognition that in the case of an insufficient radial support of the ball nut device, a wear of the ball screw drive is increased and thus the service life thereof is reduced. The advantage of the embodiments of the present disclosure is that by supporting the ball nut device in some regions in at least one contact region, an overdetermination of the contact regions is avoided and thus a particularly stable radial support of the ball nut device is made possible. Thus the radial support of the ball nut required for reliable and long-lasting operation can be improved in a simple manner, in particular by considering the radial fit design, and thus the service life of the steering gear can be extended.

In an embodiment, it is provided that at least one free region in which the ball nut device is arranged spaced-apart from the inner circumference of the cylinder chamber is formed in the circumferential direction between the contact region and the toothed portion. In particular, the free region is understood to mean a contactless region of the ball nut device or the lateral surface relative to the inner circumference of the cylinder chamber. Preferably, the lateral surface in the free region is spaced apart by a spacing of more than 0.1 mm, preferably more than 1 mm, in particular more than 5 mm, relative to the inner circumference. Preferably, the cylinder chamber is separated by the ball nut device into two cylinder chambers which are separate from one another, wherein the cylinder chambers are connected together fluidically via the free region. Preferably, the lateral surface is supported in exactly one contact region on the inner circumference of the cylinder chamber, wherein two free regions adjoin the contact region on both sides in the circumferential direction. Alternatively, the lateral surface in at least or exactly two contact regions can be supported on the inner circumference of the cylinder chamber, wherein exactly three free regions are formed in the circumferential direction between the toothed portion and the two contact regions. In other words, the contact regions and the free regions alternate in the circumferential direction, or a free region adjoins each contact region in the circumferential direction. Preferably, outside the contact regions or in the free regions, the lateral surface has a diameter and/or radius of curvature different from the contact regions. In other words, the lateral surface has a differently curved surface over the circumference. In particular, at least in the contact regions the lateral surface has a radius of curvature which conforms to the radius of the inner circumference.

A contactless arrangement of the ball nut outside the contact regions can be ensured by the free regions. A pressure compensation can also take place in a simple manner between the two cylinder chambers by connecting the cylinder chambers in terms of flow technology, whereby the operating behavior of the steering gear is improved.

In an embodiment, it is provided that the at least one, preferably exactly one, contact region is arranged opposing the toothed portion in relation to the first axis of rotation in the radial direction. In particular, the contact region is preferably located centrally and/or symmetrically on a vertical center line of the toothed portion, in particular intersecting the first axis of rotation, when viewed in cross section or in axial direction in relation to the first axis of rotation. In simple terms, in relation to the first axis of rotation the contact region is arranged offset diametrically and/or in the circumferential direction by 180° to the toothed portion.

Alternatively, the at least one contact region or optionally additionally at least one further contact region is arranged offset to the toothed portion in an angular range of greater than 90° in the circumferential direction. In particular, the at least one contact region is preferably arranged eccentrically to the center line of the toothed portion, when viewed in cross section or in the axial direction in relation to the first axis of rotation. In simple terms, the at least one contact region is arranged offset by more than 90° and/or less than 180° to the toothed portion in relation to the first axis of rotation in the circumferential direction. In particular, exactly two contact regions can be arranged in a Y-shape to the toothed portion, wherein the vertical limb is defined by the center line of the toothed portion. Thus a particularly stable support of the ball nut device in the cylinder chamber is proposed, whereby a radial force introduced via the segment shaft can be securely supported or routed into the gear housing by the at least one contact region opposing the toothed portion.

In an embodiment, it is provided that at least in the contact region the ball nut device is slidably mounted or slidably supported via a sliding layer on the inner circumference of the cylinder chamber. In particular, the sliding layer serves to reduce friction during an axial movement between the ball nut device and the gear housing. To this end, the sliding layer is selectively arranged on the ball nut device or the gear housing. Particularly preferably, the ball nut device is supported over the entire axial length or the entire contact region via the sliding layer on the gear housing. The sliding layer can extend on the inner circumference of the cylinder chamber, preferably over the entire linear movement range. Alternatively, the sliding layer can extend in the contact region of the ball nut device, preferably over the entire axial length. Preferably, the ball nut device or the gear housing has an optimized contact surface relative to the sliding layer and/or contact surface orientation at least in the contact region. In principle, the sliding layer can be formed by a sliding coating. Alternatively, the sliding layer can be formed by a separate component as described below. For example, the sliding layer can be produced by a material with optimized sliding or self-lubricating properties, in particular a metal alloy, such as for example a lead, tin, copper and/or zinc alloy, a plastics, such as for example PTFE, or technical ceramic. A low-friction linear movement of the ball nut device can be achieved by the combination of a sliding layer which is optimized in terms of friction with the ball nut device which is optimized in terms of fit, whereby the efficiency of the steering gear is increased.

In an embodiment, it is provided that the sliding layer is formed by a plain bearing sleeve arranged in the gear housing, in particular in the cylinder chamber. In particular, the plain bearing sleeve is configured circumferentially to the first axis of rotation or the worm shaft. Preferably, the plain bearing sleeve has a radial through-passage via which the ball nut device is engaged with the segment shaft. In particular, the plain bearing sleeve is preferably received positively and/or non-positively, preferably without play, in the cylinder chamber in the radial and/or in the axial direction in relation to the first axis of rotation. Thus the ball nut device forms a direct friction partner with the plain bearing sleeve. A particularly simple and cost-effective arrangement of the sliding layer in the cylinder chamber is implemented by the plain bearing sleeve.

In an embodiment, it is provided that the sliding layer is formed by a sliding element arranged at least in the contact region. In principle, the sliding element can be configured by a plain bearing sleeve which is configured circumferentially to the lateral surface and fixed to the ball nut device. Alternatively, the at least one sliding element can be formed by a sliding block or a sliding sleeve portion which is arranged at least or exclusively in the one contact region and fixed to the ball nut device. In particular, the steering gear has in each case a separate dedicated sliding element for each contact region. Thus the gear housing forms a direct friction partner with the sliding elements. A particularly cost-effective implementation of the sliding layer can be produced by the arrangement of the sliding elements on the ball nut device, since they only have to be arranged in the contact regions of the ball nut device.

In an embodiment, it is provided that the ball nut device is configured in multiple parts, wherein the ball nut device has a ball nut and a guide sleeve, wherein the ball nut is received in the guide sleeve. In particular, the guide sleeve serves for the linear guidance of the ball nut along the first axis of rotation and for receiving mechanically induced radial loads of the ball screw drive. In principle, the ball nut can be received without play inside the guide sleeve. Alternatively, however, the ball nut can also be received at least in the radial direction with little play, i.e. with a small amount of play, in the guide sleeve in order to compensate for tolerances. The guide sleeve preferably has the lateral surface and the toothed portion and thus is supported via the at least one contact region in the cylinder chamber or is in meshing engagement with the segment shaft. In particular, the guide sleeve can be designed such that it is optimized regarding radial fit and/or axial guidance. Accordingly, the ball nut can be designed such that it is optimized regarding force transmission. By accommodating the ball nut separately in the guide sleeve, these components can be optimized and/or selected independently of one another regarding their function, fit, material, design or the like.

In an embodiment, it is provided that the ball nut has a round-cylindrical shape and the guide sleeve has a shape which is preferably non-circular, deviating from the round-cylindrical shape. In particular, the guide sleeve has the deviating or non-circular shape at least on the outside, whereas the guide sleeve has a complementary shape to the ball nut on the inside. Preferably, the guide sleeve has an axial bore in which the ball nut is inserted axially and secured against loss. Preferably, the ball nut has on the inside at least or exactly one of the raceways, as already described above, in which the at least one row of balls is guided circumferentially. In particular, the ball nut has more than two, preferably more than four, in particular more than six, of the raceways. Thus a particularly simple and cost-effective production of the ball nut and the guide sleeve is proposed.

In an embodiment, it is provided that the ball nut is received at least positively in the guide sleeve in the axial and in the radial direction in relation to the first axis of rotation. Optionally, the ball nut can be received non-positively in the guide sleeve in the axial and/or radial direction in relation to the first axis of rotation. This ensures a particularly secure support and thus a particularly secure force transmission from the ball nut to the guide sleeve.

In an embodiment, it is provided that the guide sleeve has a circumferential support portion on an axial front face of the ball nut, wherein the ball nut is supported on the guide sleeve via the support portion in an axial direction in relation to the first axis of rotation. In other words, the axial bore of the guide sleeve is defined by the support portion in the axial direction. In particular, the guide sleeve is supported and/or can be supported positively on the support portion in the axial direction. In particular, the support portion extends radially inwardly and/or in a radial plane of the first axis of rotation. Preferably, the support portion is configured by a collar, flange, annular shoulder or the like, circulating around the first axis of rotation. This enables a particularly stable axial support of the ball nut on the guide sleeve.

In an embodiment, it is provided that the steering gear has a securing element which is mounted on an axial front face of the ball nut in the guide sleeve. The ball nut is supported on the guide sleeve via the securing element in an axial opposing direction, preferably opposing the axial direction. In other words, the axial bore of the guide sleeve is defined by the securing element in the axial opposing direction. In particular, the guide sleeve is supported and/or can be supported positively on the securing element in the axial opposing direction. Preferably, the securing element is positively fixed, for example via a screw connection, and/or non-positively, for example via a press fit, inside the guide sleeve or the receiving portion. For example, the securing element is configured as a securing ring circulating around the first axis of rotation. This ensures a particularly simple and secure mounting of the ball nut in the guide sleeve.

In an embodiment, it is provided that the ball nut and the guide sleeve are produced from a different material and/or have different material properties. In particular, the ball nut and the guide sleeve can have a different hardness and/or strength. Preferably, the ball nut is optimized regarding force transmission and the guide sleeve is optimized regarding fit and/or friction. In other words, the guide sleeve and the sliding layer, in particular the plain bearing sleeve, have a low-friction material pairing, preferably a low-friction material and surface pairing. Preferably, at least the guide sleeve is produced from steel or a steel alloy. Thus the efficiency and the service life of the steering gear can be further increased.

In an embodiment, it is provided that an axial length of the guide sleeve is at least 10% longer than an axial length of the ball nut. In particular, the axial length of the guide sleeve is more than 10%, preferably more than 15%, in particular more than 20%, of the axial length of the ball nut. The radial support of the guide sleeve in the gear housing can be further improved by the extended guide sleeve.

In an embodiment, it is provided that the steering gear has a key which is radially mounted in a keyway between the ball nut and the guide sleeve, wherein selectively the ball nut or the guide sleeve has the keyway. The ball nut is supported without play on the guide sleeve via the key in a radial direction in relation to the first axis of rotation. In particular, the key serves for the clamped support of the ball nut in the receiving portion. Preferably, the key is countersunk in some portions and/or mounted captively in the keyway. To this end, the keyway can be designed, for example, with an undercut, for example a trapezium shape or T-shape for the key. A mounting of the ball nut without play, preferably non-positively, in the radial direction in the guide sleeve is made possible by the key.

An embodiment of the present disclosure relates to an electric steering system for a vehicle, comprising the steering gear, as has already been described above. In particular, the electric steering system serves to convert a steering command generated by a steering handle, electrically, in particular electromechanically, to at least one steerable vehicle wheel. In principle, the vehicle can be a passenger motor vehicle, an agricultural or construction machine. Preferably, the vehicle is a utility vehicle. In particular, the electric steering system is configured as an electric power steering system (EPS). In particular, the electric power steering system has an electric servomotor for the steering assistance. In a steering process, a steering angle is predetermined by means of the steering handle as a measure of a desired wheel steering angle for the at least one steerable wheel, wherein the electric servomotor provides an additional torque for the steering assistance. In particular, to this end the electric servomotor is connected to the threaded spindle, in particular the input interface, in terms of drive technology.

Further features, advantages and effects of embodiments of the present disclosure are found in the following description.

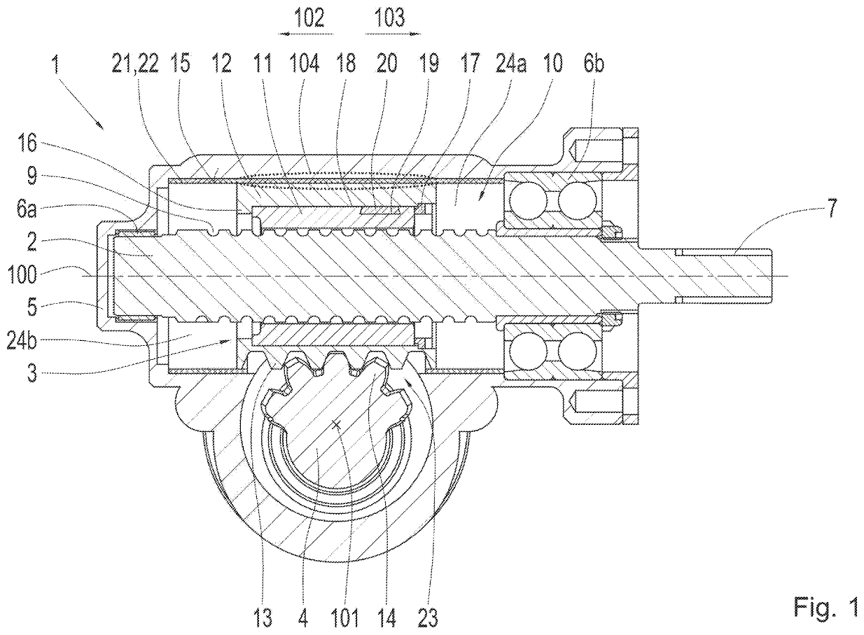

FIG. 1 shows a steering gear 1 for a vehicle which is configured as a so-called recirculating ball gear, wherein to this end an input shaft which is configured as a threaded spindle 2 is operatively connected via a ball screw drive to an output shaft which is configured as a segment shaft 4.

The steering gear 1 has a gear housing 5, wherein the threaded spindle 2 is rotatably mounted about a first axis of rotation 100 and the segment shaft 4 is rotatably mounted about a second axis of rotation 101 in the gear housing 5. To this end, the threaded spindle 2 is rotatably supported via two bearing devices 6a, 6b in the gear housing 5. For example, the bearing device 6a is configured as a needle bearing and the second bearing device 6b is configured as a two-row ball bearing. In a plan view, the first and second axes of rotation 100, 101 are oriented transversely or at right-angles to one another.

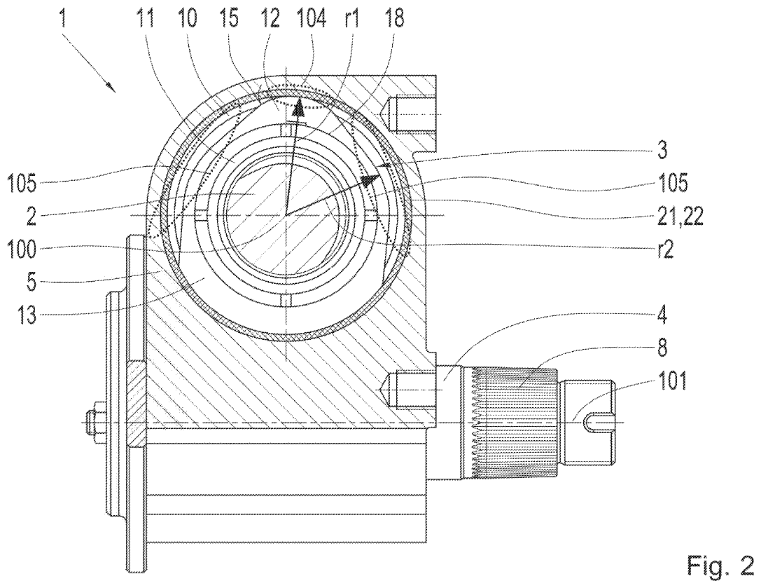

The threaded spindle 2 has an input interface 7 which is guided out of the gear housing 5 and which serves for mechanically connecting a steering drive. The input interface 7 is formed, for example, by a shaft journal which bears a positive contour, for example a spline. Accordingly, the output shaft 4 has an output interface 8, as shown in FIG. 2, which serves for mechanically connecting to the steering linkage.

The threaded spindle 2 has on its outer circumference a helical raceway 9 which serves for guiding a row of balls. The threaded spindle 2 is connected in terms of drive to a ball nut device 3 for forming the ball screw gear via the row of balls, whereby a rotational movement of the threaded spindle 2 about the first axis of rotation 100 is converted into a linear movement of the ball nut device 3 along the first axis of rotation 100. The ball nut device 3 can have on the inside a further raceway, which together with the raceway 9 forms a ball race channel for guiding the balls of the row of balls. The ball nut device 3 is arranged coaxially to the first axis of rotation 100 and is mounted displaceably in the axial direction in a cylinder chamber 10 of the gear housing 5.

The ball nut device 3 is designed in multiple parts and has a ball nut 11 and a guide sleeve 12 which is arranged in the cylinder chamber 10 for axial guidance and for radial support of the ball nut 11. To this end, the ball nut 11 is fixed inside the guide sleeve 12 at least in the axial direction in relation to the first axis of rotation 100, so that the linear movement generated by the ball nut 11 is directly transmitted to the guide sleeve 12 and this also carries out the linear movement along the first axis of rotation 100. In simple terms, the ball nut 11 is coupled in terms of movement to the guide sleeve 12 at least in the axial direction in relation to the first axis of rotation 100.

The guide sleeve 12 has on the outside a toothed portion 13 via which the guide sleeve 12 is meshingly engaged with a tooth geometry 14 of the segment shaft 4 which is configured as a segment toothing. The toothed portion 13 is formed, for example, by a rack toothing which extends in the axial direction over the entire axial length of the guide sleeve 12 and in some portions on the guide sleeve 12 in the circumferential direction. The tooth geometry 14 of the segment shaft 4 extends over an angular range of ca. 180 degrees. A longitudinal displacement of the guide sleeve 12 along the first axis of rotation 100 thus causes a rotation of the segment shaft 4 within the angular range about the second axis of rotation 101, whereby a steering angle of the vehicle is adjusted.

The guide sleeve 12 also has a lateral surface 15 which in the circumferential direction is supported in some portions in at least or exactly one fixed contact region 104 on an inner circumference of the cylinder chamber 10. For example, the contact region 104 can be defined by a non-circular shape of the lateral surface 15, deviating from the cylindrical shape of the cylinder chamber, so that the guide sleeve 12 is supported exclusively in the contact region 104 or is arranged outside the contact region 104 spaced-apart from the inner circumference of the cylinder chamber 10. In the exemplary embodiment shown, in the radial direction in relation to the first axis of rotation 100 the contact region 104 can be arranged opposingly or in the circumferential direction offset by at least 180° to the toothed portion 13. Thus for example radial forces introduced via the segment shaft 4 can be securely supported via the contact region 104.

The guide sleeve 12 has on the inside a receiving portion 18 which is configured and/or suitable for positively receiving the ball nut 11 at least in the axial direction. To this end, the receiving portion 15 is defined in an axial direction 102 in relation to the first axis of rotation 100 by a circumferential support portion 16 on which the ball nut 11 is positively supported in the axial direction 102. The support portion 16 is formed, for example, by an annular shoulder which is configured on the inner circumference of the guide sleeve 12.

Moreover, the receiving portion 15 is defined in an axial opposing direction by a securing element 17 on which the ball nut 11 is positively supported in the axial opposing direction 103. The securing element 17 is configured as a securing ring which is screwed or pressed into the guide sleeve 12. For example, the ball nut 11 is fixed between the support portion 16 and the securing element 17 without play, in particular clampingly, in the axial direction in relation to the first axis of rotation 100.

The ball nut 11 also has a keyway 19 which is incorporated on the outer circumference and which is configured, in particular, as a trapezoidal groove in which a key 20 is captively mounted. The ball nut 11 is supported via the key 20 in the radial direction inside the receiving portion 18 on the guide sleeve 12. For example, the key 20 serves for the clamping support and/or support without play of the ball nut 11 in the receiving portion 18. To this end, the key 20 is received in some portions countersunk in the receiving groove 10, whereby the key 20 forms a type of clamping contour.

The steering gear 1 also has a sliding layer 22 which is formed by a plain bearing sleeve 21 and which is arranged inside the cylinder chamber 10 in the gear housing 5, wherein the guide sleeve 12 in the at least one contact region 104 is slidably supported on the plain bearing sleeve 21 in the radial direction. For example, the sliding layer 22 can be formed by a plastics which is optimized in terms of friction, such as for example PTFE. The guide sleeve 12 forms in the contact region 104 a friction partner with the sliding layer 22 and can be produced from steel or a steel alloy. The plain bearing sleeve 21 is fixed positively and/or non-positively, preferably without play, in the cylinder chamber 10 in the axial and in the radial direction in relation to the first axis of rotation 100. To this end, the plain bearing sleeve 21 can be supported in the axial direction 102 on a radial shoulder of the gear housing 5 and in the axial opposing direction 103 on an outer ring of the second bearing device 6b.

The guide sleeve 12 is supported by the lateral surface 15 in the contact region 104 in the radial direction with little play and/or by an interference fit on an inner circumference of the plain bearing sleeve 21. To this end, the guide sleeve 12 is received with a clearance fit or a small amount of radial play of less than 30 μm in the plain bearing sleeve 21 at least in the contact region 104 in the radial direction. The plain bearing sleeve 21 has a through-passage 23, via which the tooth geometry 14 engages in the toothed portion 13, in an engagement region of the toothed portion 13 with the tooth geometry 14. For further improvement of the radial support it is provided that an axial length of the guide sleeve 12 is, for example, more than 15% longer than an axial length of the ball nut 11 in relation to the first axis of rotation 100.

It is made possible to ensure both the radial support of the ball nut device 3 required for the secure and long-lasting operation and a low-friction linear movement of the ball nut device 3 by the combination of a plain bearing sleeve 21 which is optimized in terms of friction with a guide sleeve 12 which is optimized in terms of design, taking into account the radial fit design. Thus the service life and efficiency of the ball screw drive or the steering gear 1 can be increased.

As shown in FIG. 2, the ball nut device 3 is supported in the radial direction via the guide sleeve 12 in an angular range of ca. 180° opposing the toothed portion 13 on the inner circumference of the plain bearing sleeve 21 in the contact region 104. A free region 105, via which the guide sleeve 12 is arranged spaced-apart from the inner circumference of the plain bearing sleeve 21, is formed in each case in the circumferential direction on both sides of the contact region 104.

To this end, the lateral surface 15 has a different radius r1, r2, wherein a radius rl in the contact region 104 is greater than a radius r2 in the free region 105. For example, the guide sleeve in the free region 105 is arranged spaced-apart from the plain bearing sleeve 21 with a spacing of greater than 1 mm. A first and a second cylinder chamber 24a, 24b, as shown in FIG. 1, can be connected together in terms of flow technology by the opening formed thereby, whereby a pressure compensation takes place between the two cylinder chambers 24a, 24b and the axial movement of the ball nut device 3 is not restricted.

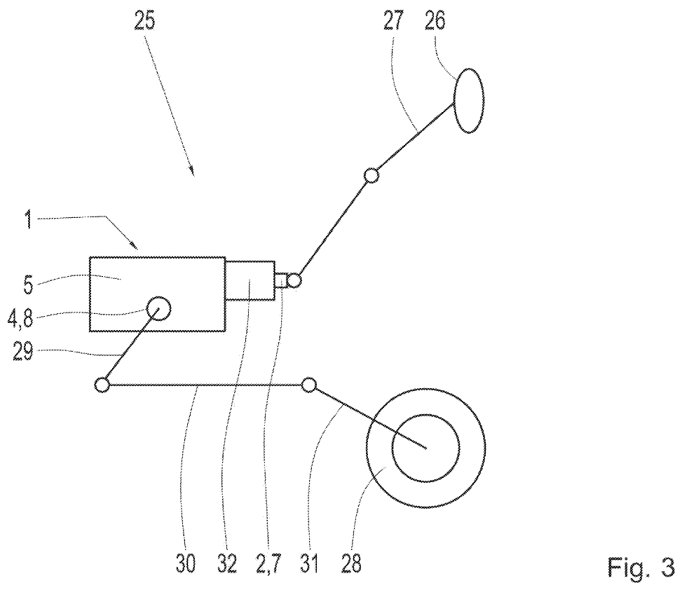

FIG. 3 shows in a highly simplified view an electric steering system 25 for a vehicle, in particular for a utility vehicle. The electric steering system 25 is configured, for example, as an electric power steering system.

The steering system 25 has a steering handle 26 which is configured as a steering wheel and which is connected via a steering column 27 to the steering gear 1, as described in FIG. 1. The steering gear 1 serves to set a wheel steering angle of at least one steerable vehicle wheel 28 of the vehicle, as a function of a rotation of the steering column 27. To this end, the steering column 27 is connected to the threaded spindle 2, in particular the input interface 7 and the segment shaft 4, in particular the output interface 8, is connected via a steering column lever 29 to a steering linkage 30, wherein a rotational movement of the steering column 27 is translated via the ball screw drive 3 into a pivoting movement of the steering column lever 29. The ball screw drive 3 increases the rotational movement of the segment shaft 4 resulting from the actuation of the steering handle 26. The rotational movement of the segment shaft 4 is in turn converted via the steering column lever 29 into a linear movement of the steering linkage 30, which is connected via a track lever 31 to the vehicle wheel 28 to be steered, in order to set the corresponding wheel steering angle on the vehicle wheel 28.

Moreover, the steering system 25 can have an electric drive motor 32 which is coupled to the steering gear 1 in terms of drive technology for applying an additional torque. For example, the drive motor 31 and the steering column 27 can act together on the threaded spindle 2 of the steering gear 1. Thus the steering column 27 and the drive motor 32 form a steering drive of the steering system 1. The electric drive motor 32 is configured as an electric servomotor.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1 Steering gear
2 Threaded spindle
3 Ball nut device
4 Segment shaft
5 Gear housing
6a, b Bearing device
7 Input interface
8 Output interface
9 Raceway
10 Cylinder chamber
10 Ball nut
12 Guide sleeve
13 Toothed portion
14 Tooth geometry
15 Lateral surface
16 Support portion
17 Securing element
18 Receiving portion
19 Keyway
20 Key
21 Plain bearing sleeve
22 Sliding layer
23 Through-passage
24a, b Cylinder chamber
25 Steering system
26 Steering handle
27 Steering column
28 Vehicle wheel
29 Steering column lever
30 Steering linkage
31 Track lever
32 Drive motor
100 First axis of rotation
101 Second axis of rotation
102 Axial direction
103 Axial opposing direction
104 Contact region
105 Free region

1. A steering gear for a steering system of a vehicle, comprising:
a gear housing, wherein the gear housing has a cylinder chamber;
a threaded spindle rotatably mounted in the gear housing, wherein the threaded spindle has an input interface for connecting a steering drive;
a segment shaft rotatably mounted in the gear housing, wherein the segment shaft has an output interface for connecting to a steering linkage; and
a ball nut device which is guided axially in relation to a first axis of rotation of the threaded spindle and which has a lateral surface and a toothed portion for meshing engagement with the segment shaft wherein the ball nut device forms, together with the threaded spindle, a ball screw drive,
wherein the lateral surface is supported in some portions in at least one fixed contact region on an inner circumference of the cylinder chamber in a circumferential direction.

2. The steering gear as claimed in claim 1, thatwherein at least one free region in which the ball nut device is arranged spaced-apart from the inner circumference of the cylinder chamber is formed in the circumferential direction between the contact region and the toothed portion.

3. The steering gear as claimed in claim 1, wherein the at least one contact region is arranged opposing the toothed portion in relation to the first axis of rotation in a radial direction and/or is arranged offset to the toothed portion in an angular range of greater than 90° in the circumferential direction.

4. The steering gear as claimed in claim 1, wherein at least in the contact region the ball nut device is slidably mounted via a sliding layer in the cylinder chamber.

5. The steering gear as claimed in claim 4, wherein the sliding layer is formed by a plain bearing sleeve arranged in the cylinder chamber.

6. The steering gear as claimed in claim 4, wherein the sliding layer is formed by at least one sliding element arranged in the contact region.

7. The steering gear as claimed in claim 1, preceding thatwherein the ball nut device is configured in multiple parts, wherein the ball nut device has a ball nut and a guide sleeve and wherein the ball nut is received without play in the guide sleeve.

8. The steering gear as claimed in claim 7, thatwherein the ball nut has a round-cylindrical shape and guide sleeve has a shape deviating from the round-cylindrical shape.

9. The steering gear as claimed in claim 7, thatwherein the ball nut is received at least positively in the guide sleeve in an axial direction and in a radial direction in relation to the first axis of rotation.

10. The steering gear as claimed in claim 7 wherein the guide sleeve has a circumferential support portion on an axial front face of the ball nut, and wherein the ball nut is supported on the guide sleeve via the support portion in an axial direction.

11. The steering gear as claimed in claim 7, comprising a securing element, wherein the securing element is mounted on an axial front face of the ball nut in the guide sleeve, and wherein the ball nut is supported on the guide sleeve via the securing ring in an axial opposing direction.

12. The steering gear as claimed in claim 7, wherein the ball nut and the guide sleeve are produced from a different material and/or have different material properties.

13. The steering gear as claimed in claim 7, wherein an axial length of the guide sleeve is at least 10% longer than an axial length of the ball nut.

14. The steering gear as claimed in claim 7, bycomprising a key which is mounted in a keyway of the ball nut or the guide sleeve wherein the ball nut is supported without play on the guide sleeve via the key in a radial direction.

15. An electric steering system for a vehicle, comprising the steering gear as claimed in claim 1.
